(19) United States
(12) Patent Application Publication
(10) Pub. No.: US 2020/0057714 A1
(43) Pub. Date: Feb. 20, 2020

(54) TESTING DATA CHANGES IN PRODUCTION SYSTEMS

(71) Applicant: Google LLC, Mountain View, CA (US)

(72) Inventors: Ayla Ounce, Sunnyvale, CA (US); Logan Alexander Bissonnette, San Jose, CA (US)

(21) Appl. No.: 16/104,330

(22) Filed: Aug. 17, 2018

(51) Int. Cl. G06F 11/36

(52) U.S. Cl. CPC G06F 11/3692; G06F 11/3688

(57) ABSTRACT

Methods, systems, and apparatus, including computer programs encoded on a computer storage medium, for obtaining copies of resources at a canary server and from a hosting server. The resources include initial instructions for responding to requests from an external device. The canary server executes an update that modifies the initial instructions in the resources to create modified instructions. A request router determines a routing of a request for resources that render a webpage based on parameters in the request. The request is processed using the modified instructions rather than the initial instructions and in response to the request router determining that the canary server is a destination of the determined routing of the request. The system determines a reliability measure of the update when the request is processed at the canary server. The reliability measure identifies whether the update will trigger a fault during execution at production servers of the system.

### BACKGROUND

This specification relates to computing devices for testing changes to data used in production computer systems.

External users can require time sensitive access to software and data resources provided by a computer system. For example, the computer system can be a set of production servers that process resources to render digital content integrated in a webpage. Changes to data (e.g. software or other data of a resource) used at a production system can cause instability in the production system. Changes to data used at the production system can also cause interruptions to computing services that are provided to external users by the production system.

### SUMMARY

Methods, systems, and apparatus, including computer programs encoded on a computer storage medium, for obtaining copies of resources at a canary server and from a hosting server. The resources include initial instructions for responding to requests from an external device. The canary server executes an update that modifies the initial instructions in the resources to create modified instructions. A request router determines a routing of a request for resources that render a webpage based on parameters in the request. The request is processed using the modified instructions rather than the initial instructions and in response to the request router determining that the canary server is a destination of the determined routing of the request. The system determines a reliability measure of the update when the request is processed at the canary server. The reliability measure identifies whether the update will trigger a fault during execution at production servers of the system.

One aspect of the subject matter described in this specification can be embodied in a computer-implemented method performed using a system for testing data changes in production computing servers. The method includes, obtaining, at a canary server, a first copy of resources that include initial instructions for responding to requests from an external device, the first copy of resources being obtained from a hosting server; executing, at the canary server, an update that modifies the initial instructions in the first copy of resources to create modified instructions; and determining, by a request router, a routing of a first request for resources based on parameters in the first request, wherein the first request is received from the external device to obtain resources that render a webpage. The method further includes, in response to the request router determining that the canary server is a destination of the determined routing of the first request, processing the first request for resources using the modified instructions in the first copy of resources rather than the initial instructions; and determining a reliability measure of the update when at least the first request is processed at the canary server, wherein the reliability measure identifies whether the update will trigger a fault during execution at the production computing servers.

These and other implementations can each optionally include one or more of the following features. For example, in some implementations, determining the routing of the first request for resources includes: determining a destination of the routing of the first request from among the canary server and the hosting server based on a subset of parameters in the first request. In some implementations, the reliability measure indicates a probability of a fault occurring at the hosting server when the update modifies instructions in resources at the hosting server. In some implementations, determining the reliability measure of the update includes: executing the modified instructions at the canary server for multiple different requests over a predetermined time duration; and determining, for each of the multiple different requests, whether a fault condition occurs in response to executing the modified instructions using the canary server.

In some implementations, determining the reliability measure of the update includes: processing a plurality of requests for a predetermined time duration using the modified instructions in the first copy of resources; and detecting whether a fault occurs in a serving cell of the canary server that obtains resources for responding to a particular request in the plurality of requests. In some implementations, the method further includes, generating, responsive to execution of the update, multiple resource versions, each resource version including a distinct copy of resources obtained from the hosting server and a respective timestamp that indicates a time the resource version was generated.

In some implementations, the method further includes, determining that a fault condition occurred in response to executing the modified instructions using the canary server; obtaining, from the storage device, a first resource version for loading at the hosting server based on the respective timestamp for the first resource version indicating the first resource version was generated before the fault condition occurred; and using the first resource version loaded at the hosting server to process a plurality of requests for resources from multiple external devices following the fault condition.

In some implementations, determining that the fault condition occurred includes determining that the fault condition occurred at the canary server and the method further includes: using the first resource version to process the plurality of requests at the hosting server for a time duration that is limited by the existence of the fault condition at the canary server. In some implementations, determining that the fault condition occurred includes determining that the fault condition occurred at the canary server and the method further includes: determining, by the request router, that the hosting server is a destination of a determined routing for a second request, based on the fault condition having occurred at the canary server; and processing the second request at the hosting server using a prior version of resources in response to detecting that the fault condition occurred at the canary server, the prior version of resources having been previously loaded at the hosting server.

Other implementations of this and other aspects include corresponding systems, apparatus, and computer programs, configured to perform the actions of the methods, encoded on computer storage devices. A computing system of one or more computers or hardware circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

Particular embodiments of the subject matter described in this specification can be implemented so as to realize one or more of the following advantages. This document describes techniques for reliably isolating certain types of requests that are received at a production computer system. For example, requests that require access to resources that have been recently modified are effectively and efficiently isolated from other types of requests that use resources which are known to be stable, so as to prevent those recently modified resources disrupting the normal operation of the resources that are known to be stable, which improves the functioning of the computer by reducing the number (or likelihood) of faults. The described techniques enable software changes in resources of a set of servers to be introduced and tested in real-time, without degrading or adversely affecting performance of computer servers tasked with supporting on- going production tasks. Thus, the techniques discussed in this document enable more efficient and effective updates to the computer system without requiring the computer system to be taken offline.

A production system includes a special-purpose routing device that detects and routes requests to a host server or a canary server that each use a certain version of resources to process requests received from external devices. The canary servers allow the system to publish and assess software updates without degrading services of the production system that are provided to large sets of external users. Using the routing device and servers, system instabilities or potential faults that might occur from new software changes are isolated to a limited subset of the users and sub-system in the canary servers. The described techniques enable the testing of data changes in production servers that previously could not be performed by computer systems in an efficient manner and/or without taking the servers offline. The techniques therefore improve the stability and reliability of the production system while at the same time enabling timely serving of content using updated resources where access to the serving by the updated resources may be required or beneficial.

The techniques enable computing systems to perform operations that the systems were previously unable to perform due to the challenges of effectively evaluating, in real-time, software changes submitted to a production system from users that are external to the system. As such, the described technology improves the efficiency of the computer system operation, which is an improvement to the computer system itself.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for testing data changes in a production computer system.

FIG. 2 is a block diagram showing an example routing of data for testing software changes in a production computer system.

FIG. 3 is a flowchart of an example process for testing data changes in a production computer system.

FIG. 4 is a block diagram of an example computing system that can be used in connection with methods described in this specification.

Like reference numbers and designations in the various drawings indicate like elements.

### DETAILED DESCRIPTION

This document describes techniques for real-time testing of data changes in production computer systems. The techniques prevent a production system from going off-line or becoming unavailable when changes are made to system data used by a particular set of computing servers at the production system. The subject matter describes additional computing elements which enable prior versions of system data to be accessed and loaded in response to detecting that certain fault conditions have occurred. For example, a fault condition that occurs at the production system can reveal an instability with a new or updated version of software executed by the particular set of servers. The additional computing elements are configured to analyze performance of the new software version while concurrently and dynamically capturing prior versions of stable system data. The described techniques are implemented to detect the occurrence of a fault condition and trigger the rapid loading of prior versions of system data. This ensures production systems remain available to continue processing real-time user requests for resources while the reliability of software changes are tested at certain servers.

In this context, special-purpose computing elements are described which enable modifications to specific portions of data (e.g., software instructions) in the production system. These modifications can include providing or loading a new software version while the production system simultaneously processes user requests to serve resources that were recently modified (e.g., “fresh” resources) in real-time. The production system can include multiple computing servers that manage resources such as digital media content served to a requesting user/client device that is external to the system. For example, one computing server can be a web-server that stores resources including hypertext markup language tags (HTML tags) and JavaScript content that cause video content to be rendered at a display of the client device (e.g., a smartphone or tablet). The computing elements are configured such that the production system can process the user requests while simultaneously guarding against instabilities from data changes that cause service outages at the production system.

The computing elements interact to evaluate the reliability and stability of changes to system data used by the production system. The techniques include using a canary copy of system data that runs on a first set of canary servers at the production system in conjunction with using a stable or “golden” copy of system data that runs on a second set of hosting servers at the production system. The canary copy of system data can be a stable prior version of software that is modified to include a new version of software. Among the computing elements is a special-purpose routing device that is uniquely configured to communicate with the canary servers and the hosting servers. The routing device detects new user requests that must be processed at the production system using the new software version. These user requests are routed to the canary server and processed using the new software version. During this time, the new software version is evaluated to determine its long-term reliability and stability.

If a fault condition is caused by the new software version, the computing elements interact to efficiently detect the occurrence of the fault condition. A source of the fault condition is also determined and the condition is isolated to a particular set of computing servers. In response to detecting that the fault condition is caused by the new software version, a prior golden copy of system data is quickly obtained and loaded such that the production system remains available to process user requests.

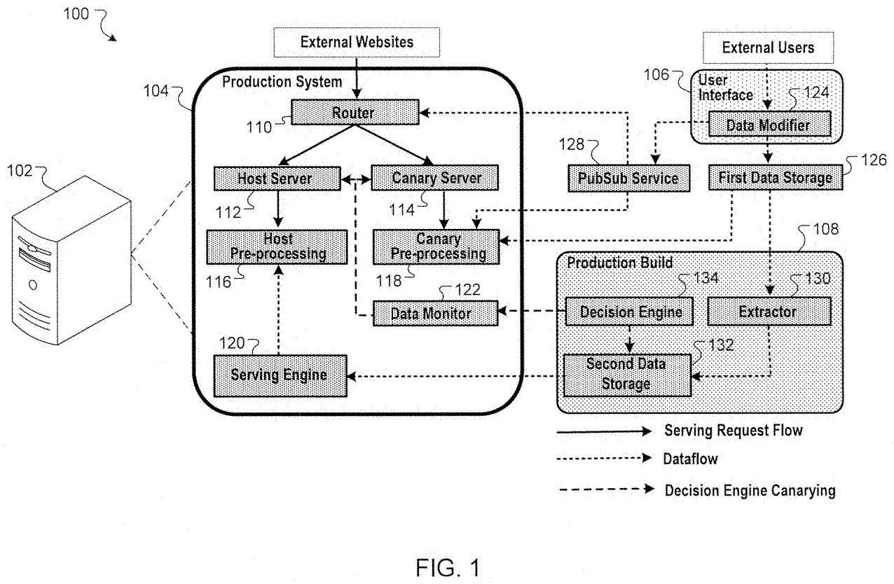

FIG. 1 is a block diagram of an example system 100 for testing changes to system data in a production computer system 104. As used in this document, data or system data can include all types of data that may be accessed or used by a production computer system when responding to resource requests from internal and external devices. The data can include one or more of: software instructions, resources such as items of digital media content (e.g., images or video) that may be served to a requesting device, other types of data that support using the software instructions to serve resources to a requesting device, or combinations of each. A resource or set of resources can include software instructions that affect how a resource is served to a device, the types of resources that are served to a device, or the types of information or media content included in a resource that is served to a device. For example, the software instructions may cause a resource to be served in a streaming format (e.g., live streaming), a downloadable format, or both. A change to system data used by a production system can include at least updating or modifying a resource, updating or modifying software instructions or other data associated with a resource, or a combination of each. System 100 includes a server system 102 that executes programmed instructions for implementing sets of computing servers that are included in a production system 104. The production system 104 can include one or more sets of computing servers. For example, the production system 104 includes a host server 112 that can represent one or more sets of computing servers and a canary server 114 that can also represent one or more sets of computing servers. The sets of computing servers each access (and/or process) system data, such as software and other electronic resources, in response to receiving a request from an external device or user.

In some implementations, the computing servers access and use the resources to create, generate, or otherwise obtain digital media content. The obtained digital content is provided for output at a display of an example external computing device. The digital content may be images, text, active media, streaming video, or other graphical objects that are presented at an example webpage or external website. In some cases, an external device that makes a request for resources is a publisher device that also interacts with production system 104 to modify instructions included in resources of production system 104. For example, a publisher device causes the production system 104 to update instructions included in resources (e.g., for a portion of system data) of the production system 104. The instructions can be program code or software instructions used by the production system 104 to render digital content owned, or managed, by the publisher.

External devices, computing devices, and at least one server in production system 104, can be any computer system or electronic device that communicates with a display to present an interface or web-based data to a user. For example, the devices can be a desktop computer, a laptop computer, a smartphone, a tablet device, a smart television, an electronic reader, an e-notebook device, a gaming console, a content streaming device, or any related system that is configured to receive user input via the display. The devices may also be a known computer server on a local network, where the server is used to provision web-based content to devices that are external to the network.

In some implementations, a dataset of resources is allocated to a data container that corresponds to a publisher. The publisher modifies instructions in resources of the container and publishes serving data, which includes a new dataset of resources that have the modified instructions. The published serving data can be served to external users in response to a request for resources. The serving data can cause digital content for a movie or audio podcast to be streamed at an external client device. In some implementations, the publisher modifies the instructions to change a type of digital content that is rendered, or streamed, at the external client device or to change the manner in which digital content is rendered to an external device. In some cases, the publisher modifies the instructions and then sends a request to production system 104 to assess or evaluate the modification to the instructions.

Production system 104 can serve container tags (e.g., snippets of JavaScript code) to achieve a data serving function that allows modifications to instructions (e.g., an update) to become live within seconds and durable in under fifteen minutes. An update can be received from publisher devices or users that are external to a network of system 100 or devices and users that are internal to the network. In some implementations, updates are received for processing at production system 104 through an example container tag configuration service represented by Data Modifier 124. The Data Modifier 124 communicates with a user interface (UI) 106 to receive resource updates that are processed at system 100.

In general, system 100 includes data and other resources that can be modified while production system 104 runs in a production mode to respond to requests from external devices. In one implementation, system 100 may be a large-scale computer system that is used (or managed) by a content streaming entity. In this context, system 100 uses production system 104 to provide resources for supporting an example webpage (www.example.com/videos) that presents streaming media content to external devices. For example, production system 104 can use a set of servers that execute software instructions to provide content to an external device. The content (e.g., streaming video content) is provided to the client device in response to production system 104 receiving a request, from the client device, for resources that cause the video content to be provided, e.g., in a streaming format at the client device.

As indicated above, an external user may submit an update, such as a software change request that affects resources linked to a container tag at production system 104. In some cases, an update may degrade performance of a production mode of the production system 104. For example, an external user's software change to a container's tag may cause an example serving binary to suddenly crash. In some implementations, software updates, or modified instructions in a resource, can cause a service outage at production system 104 that adversely affects a user's ability to receive streaming content via system 100.

With reference to the above context, this document describes techniques that include sending resource updates submitted by external (or internal) publishers to canary server 114. The updates modify (e.g., in real-time) instructions in resources linked to a container tag at production system 104. The canary server 114 provides a redundant copy of resources as well as other data that host server 112 uses to run a production mode of system 104. Canary server 114 is used to test updates and modifications to instructions in order to determine a reliability measure of an update. In some implementations, updates are either sent directly to canary server 114 or by updating an example back-up data store for canary server 114.

This document also describes techniques for implementing a request router 110. The request router 110 is configured to determine whether requests should be sent to host server 112 or canary server 114. For example, instead of making a request to host server 112 or canary server 114 directly, the request router 110 functions as an intermediary device that arbitrates a routing of requests based on a set of computing rules. So, rather than making requests directly to the servers of production system 104, system 100 detects an incoming request for resources from a user (or external device) and sends the detected request to request router 110. The request router 110 references or uses the set of computing rules to determine a routing of the detected requests. In some cases, using the computing rules includes referencing data that identifies a recent update that was made to a copy of resources at the canary server 114.

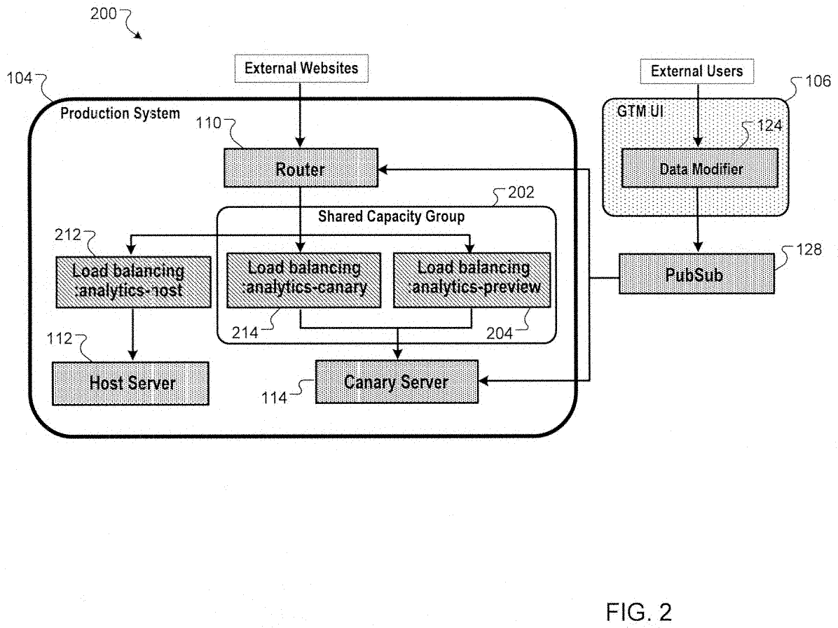

For example, the computing rules can specify that detected incoming requests be sent to canary server 114 if data identifying an update indicates the update occurred within the last 30 minutes. Alternatively, the rules can also specify that detected incoming requests be sent to canary server 114 until a user manually specifies that incoming requests be sent elsewhere (e.g., to host server 112). As described in more detail below with reference to FIG. 2, the set of computing rules can also specify that detected incoming requests be sent to host server 112 in response to system 100 determining that one or more sub-systems at canary server 114 are “unhealthy.” For example, sub-systems at canary server 114 are “unhealthy” if system 100 determines that: i) a system error has occurred at canary server 114, ii) a sub-system of canary server 114 has not responded within a threshold time duration, or iii) canary server 114 has experienced a serving binary crash or a sub-system crash.

Production system 104 includes a host pre-processing server 116 that communicates with host server 112 and a canary pre-processing server 118 that communicates with canary server 114. Host pre-processing server 116 and canary pre-processing server 118 are each one or more computing devices configured to support certain data serving functions. The functions can include protections that mitigate the occurrence of system crashes or fault conditions at the respective set of servers to which pre-processing server 116, 118 is connected. Functions relating to canary pre-processing server 118 will be described initially, while functions relating to host pre-processing server 116 are described below with reference to a build pipeline 108 of system 100.

Based on a received request that is routed to canary server 114, canary pre-processing server 118 can pre-process data obtained from resources for serving to a client device as a response to the received request. In some implementations, canary pre-processing server 118 includes a cache memory for storing a received update that modifies software instructions in a set of resources. Canary pre-processing server 118 communicates with first data storage 126 to receive and cache/store the received updates. First data storage 126 stores updates submitted to system 100 from an external device via user interface 126 and Data Modifier 124. In some implementations, if request router 110 determines that canary server 114 is a destination of a routing of a request received from a client device, then canary server 114 can serve data for responding to the request from the cache memory of the canary pre-processing server 118. Canary pre-processing server 118 can obtain requests from Data Modifier 124 via a subscriber service 128 (described below) whenever an update request is received. Canary pre-processing server 118 should therefore always have the latest data. In some cases, canary pre-processing server 118 may be required to restart, which may result in server 118 losing some (or all) of its stored data. If this occurs, canary pre-processing server 118 is configured to re-read or re-obtain data from subscriber service 128 upon reloading or restarting is computing processes. If canary pre-processing server 118 receives a request for data it does not currently have, then the canary pre-processing server 118 communicates with first data storage 126 to retrieve the latest copy of the requested data.

System 100 includes a publisher subscriber (Pub Sub) service 128 that also communicates with data storage 126 to record received resource updates submitted by an example publisher. The subscriber service 128 can be configured as a forwarding service that sends messages to router 110 and canary pre-processing server 118. In some implementations, the subscriber service 128 corresponds to a seek-back log that is used to record published updates. In some cases, Data Modifier 124 receives an update via interface 106 and uses data storage 126 and subscriber service 128 to publish the update for integration at canary server 114.

Build pipeline 108 is used by system 100 to create snapshots of resource data. Build pipeline 108 generally includes a data extractor 130, a second data storage 132, and a decision engine 134. Build pipeline 108 uses data extractor 130 to read or obtain data stored at data storage 126 and then generates a build snapshot based on the obtained data. Build snapshots are copied to data storage 132. A serving engine 120 reads or obtains build snapshots copied to data storage 132 and causes the obtained build snapshots to be served to host server 112. In some implementations, serving engine 120 includes a low-latency read-only data store that functions as a back-up data store for host server 112.

Serving engine 120 can be a primary storage backend for host pre-processing server 116. As described in more detail below, serving engine 120 is configured to support data rollbacks, which can maintain stability of system 100 in the event of an unexpected service outage. Serving engine 120 is configured to access and load prior versions of resources or a snapshot of system data stored in second data storage 132, such as a flash memory device. The memory can have low latency (e.g., <1 millisecond). The low latency characteristic of the memory at second data storage 132 provides an added benefit whereby a prior resource version can be quickly retrieved and loaded at host server 112 (e.g., within minutes). Data retrieval and loading operations that are occur with low latency allow stable or safe software versions to be quickly re-loaded at a server to mitigate disruptions caused by corrupt data at the server. In some implementations, system 100 uses serving engine 120 and build pipeline 108 to generate and load multiple prior resource versions. Each prior resource version can include a distinct copy of resources obtained from host server 112 and a respective timestamp that indicates a time the resource version was generated.

System 100 stores copies of the multiple prior resource versions in data storage 132 (e.g., using flash memory). The flash memory of second data storage 132 can have a latency attribute that corresponds to an amount of time required to obtain a particular resource version stored in the flash memory. System 100 can generate the multiple resource versions before, or in response to, executing a software update submitted by a publisher. In some implementations, a latency attribute that corresponds to an amount of time required to obtain the particular resource version stored in a storage device (e.g., the local flash memory second data storage 132) is less than 10 minutes or between five minutes and 10 minutes.

Decision engine 134 is configured to provide a canary service for host server 112 and interacts with serving engine 120 to regulate the flow of serving data to host pre-processing server 116 and host server 112. For example, decision engine 134 communicates with data storage 132 to detect or determine that a new build snapshot is generated and stored at data storage 132. In response to detecting a new build snapshot, decision engine 134 canaries the new snapshot at a new cell of serving engine 120 for use at a serving stack of host server 112. In general, build snapshots are used by host server 112 to serve data as a response to requests for resources. Host server 112 serves the data from a build snapshot (e.g., canary data) in response to request router 110 determining that host server 112 is a routing destination of a request received from a client device. This serving method mitigates exposing sets of servers, e.g., that support production mode tasks, in host server 112 to potentially corrupt software that may be included in a recent update submitted by a publisher.

A technique of using canary data at host server 112, the testing of new software updates at canary server 114, and the splitting of serving traffic between these two stacks, reduces a likelihood that an update having corrupt code will adversely affect large segments of data traffic processed at system 100, thereby improving the functioning of the system itself by making the system more reliable. For example, based on its determinations, request router 110 ensures that canary server 114 receives only serving traffic (e.g., resource requests) that must be served with fresh data, such as recently modified resources. Such serving traffic can generally include queries or requests relating to updates that were recently published and are “live” as well as requests for previewing a recently published update that is not yet live. Host server 112 can be provisioned to serve 100% of all expected traffic received at production system 104. In some implementations, in response to determining that a fault condition or system outage is present in canary server 114, request router 110 routes, to host server 112, requests for resources that include a recently published update. In this case, requests routed to host server 112 may be served with stale data rather than the more fresh data that may be loaded at canary server 114.

Decision engine 134 is configured to obtain information from data monitor 122 that describes a current health status of the host server 112 and canary server 114. Based on interactions between decision engine 134, data monitor 122, and serving engine 120, an existing build snapshot being used at host server 112 can be rolled back to a prior build snapshot or resource version. For example, system 100 can revert back to a prior version of resources or a prior configuration of data at production system 104 in response to determining that first data storage 126 has received an update submission that includes harmful or corrupt data.

System 100 can revert back to a prior resource version by referencing a date and/or a timestamp of a prior build snapshot. In some implementations, a snapshot of resources can be “frozen” at a particular date or time as a remediation measure in response to system 100 determining that a fault condition or system crash has occurred at production system 104. Based on these techniques, system 100 can quickly serve a prior reliable version of data by accessing an earlier snapshot, e.g., using serving engine 120, to ensure that production mode tasks are not adversely affected by service outages due to a corrupt software update. System 100 can determine that a fault condition occurred in response to executing modified instructions using canary server 114.

In some implementations, system 100 may need to obtain a prior resource version for loading at host server 112, for example, if corrupt code has caused (or is likely to cause) a service outage at host server 112. System 100 obtains the prior resource version based on a respective timestamp for the prior resource version indicating the prior resource version was generated before the occurrence of a fault condition or system outage. System 100 loads the prior resource version at host server 112 and uses the resources in the prior version to process requests for resources that are received from external (or internal) client devices after occurrence of the fault condition. For example, host server 112 can obtain prior resource versions from host pre-processing server 116, which obtains data for a prior resource version from serving engine 120, which in turn accesses second data storage 132 to obtain data for the prior resource version.

In some implementations, system 100 determines that the fault condition occurred at the canary server 114 and then uses the prior resource version to process the requests at host server 112 for a time duration that is limited by how long the fault condition persists at the canary server 114. In some implementations, data monitor 122 monitors canary server 114, determines that the fault no longer affects canary server 114, and indicates that canary server 114 can resume processing requests e.g., using recently modified instructions. Based on this indication, request router 110 can redirect requests for processing using the modified instructions in the resources or the modified containers at canary server 114.

In other implementations, system 100 determines that the fault condition occurred at the canary server 114. Based on this determination, request router 110 determines that host server 112 is a destination of a determined routing for a next subsequent request that is received after detection of the fault condition at canary server 114. Hence, the next subsequent request is processed at host server 112 using a prior version of resources in response to system 100 detecting that the fault condition occurred at canary server 114. In most cases, the prior version of resources corresponds to a build snapshot having data that was previously loaded at the host server 112.

System 100 may further include multiple computers, computing servers, and other computing devices that each have processors or processing devices and memory that stores compute logic or software/computing instructions that are executable by the processors. In some implementations, multiple computers can form a cluster of computing nodes or multiple node clusters that are used to perform the computational and/or machine learning processes described herein. In other implementations, production system 104 and other physical computing elements of system 100 are included in server system 102 as sub-systems of hardware circuits having one or more processor microchips.

In general, server system 102 can include processors, memory, and data storage devices that collectively form one or more sub-systems or modules of server system 102. The processor microchips process instructions for execution at server system 102, including instructions stored in the memory or on the storage device to display graphical information for an example interface (e.g., a user interface 106). Execution of the stored instructions can cause one or more of the actions described herein to be performed by server system 102 or production system 104.

FIG. 2 is a block diagram showing an example routing of data for testing software changes in a production computer system. As discussed above, production system 104 includes request router 110 that is configured to determine a routing of a request for resources based on parameters in the request. In some cases, the requested resources are used to render a webpage at a client device or to enable streaming of content at the client device.

A request can have an identifier (ID) for a uniform resource locator (URL) (or another resource identifier) that is associated with the request. The request router 110 detects an incoming request, reads an ID for a URL query parameter associated with the request, and forwards the request to either the host server 112 or canary server 114 based on an internal routing map of the request router. In some implementations, request router 110 maintains at least two data structures that are associated with the internal routing map and that are used by the request router to determine whether a request should be routed to host server 112 or canary server 114.

A first data structure is represented as an example ConcurrentHashMap. Subscriber service 128 generates one or more messages that each causes insertion into a ConcurrentHashMap that includes one or more RoutingRules. For example, information associated with a message is inserted at a key determined by an ID of the request and a parameter value of a type RoutingRule. In some implementations, in response to receiving a request, the system parses information in the request to obtain an ID derived from a URL of the request and uses the ID to retrieve a RoutingRule associated with the ID (if a rule exists). A key can represent an ID that comes from, or is derived from, a URL of the request provided by a client device of a user. In some cases, a request is a Hypertext Transfer Protocol (HTTP) GET request that is received from an external website that is requesting a resource or set of resources.

For each request for resources that is received at request router 110, the router parses the ID parameter for the URL, and performs a look up in the ConcurrentHashMap to determine whether a RoutingRule exists in the HashMap for the parsed ID parameter. If the request router 110 determines that a RoutingRule exists, and that the RoutingRule is still active, then the request router 110 determines a routing destination of the request. Determining a routing destination of the request can include determining whether a canary load balancing target 214 is healthy (e.g., not running corrupt data) and can receive the request. Request router 110 routes the request to canary analytics 214 in response to determining that canary analytics 214 is healthy.

A second data structure is represented as an example priority queue. In general, a priority queue is a type of container adaptor that is specifically configured so that its first element is always the greatest of the elements it contains. This can be similar to a heap, where elements can be inserted at any moment, and only the max heap element (e.g., the one at the top in the priority queue) can be retrieved. Each message generated by subscriber service 128 also causes insertion of the RoutingRule into a max heap corresponding to the second data structure. The top element is the oldest router entry and enables deletion of RoutingRules in the HashMap. In some implementations, request router 110 schedules a timeout event every k minutes (e.g., every 30 minutes) to pop the top elements off of the max heap. The popped elements are deleted from the ConcurrentHashMap, presuming the elements have not already been replaced by data for a more recently published software change.

Production system 104 includes at least three load balancing targets 212, 214, 204 that are each used for routing traffic to host server 112 or canary server 114. Host analytics 212 is used to communicate with one or more sets of servers at host server 112 for routing request traffic to host server 112. A shared capacity group 202 is formed from preview analytics 204 and canary analytics 214 that each communicate with one or more sets of servers at canary server 114 for routing request traffic to canary server 114. In general, shared capacity group 202 is configured to prioritize preview traffic over canary traffic based on a respective routing logic of preview analytics 204 and canary analytics 214. In some implementations, the request router 110 routes a request to canary analytics 214 for routing to canary server 114 based on a determined health status of the canary analytics 214.

As indicated above, request router 110 determines a routing of incoming requests for resources based on parameters of the requests. In some implementations, request router 110 is configured to access a set of identifiers that indicate respective container tags for updated resources. For example, in response to Data Modifier 124 receiving an update from an external client device of a user, the Data Modifier 124 forwards the update to subscriber service 128, which then forwards the update to request router 110, e.g., by causing a message to be generated and sent to router 110 that includes the update. The message is received by request router 110 from subscriber service 128. The received message can include or contain all data necessary for request router 110 to determine a routing of the request or update associated with the message. A message can be analyzed against sets of identifiers that identify types of requests from a client device that will be affected by the updated resources and that should be routed to the canary server 114 for processing. In some implementations, the sets of identifiers are used to define one or more RoutingRules in the ConcurrentHashMap. The request router 110 uses at least the identifiers and parameters in a received request (or a message) to determine a routing of the received request.

In general, request router 110 is a special-purpose routing device that is uniquely configured to communicate with the host server 112 and the canary server 114. Request router 110 is configured to determine whether a received request for resources should be routed to host server 112 or canary server 114. For example, in response to detecting that a new user request has been received at the production system 104, the request router 110 analyzes the new user request for resources and, based on the analysis, determines whether the request must be processed at production system 104 using the new software version. As indicated above, the basis for the determination can include the request router 110 reading and/or parsing an ID parameter for the URL associated with the request and performing a look up in the ConcurrentHashMap to determine whether a RoutingRule exists for the parsed ID parameter. In some implementations, the RoutingRule references the sets of identifiers that identify types of requests that should be processed using the updated resources. An outcome of the analysis can involve identifying a RoutingRule for the parsed ID parameter, where the RoutingRule specifies that the request is a type of request that should be routed to the canary server 114. The user request is routed to canary server 114 and processed using the updated resources of a new software version that is loaded for testing at the canary server.

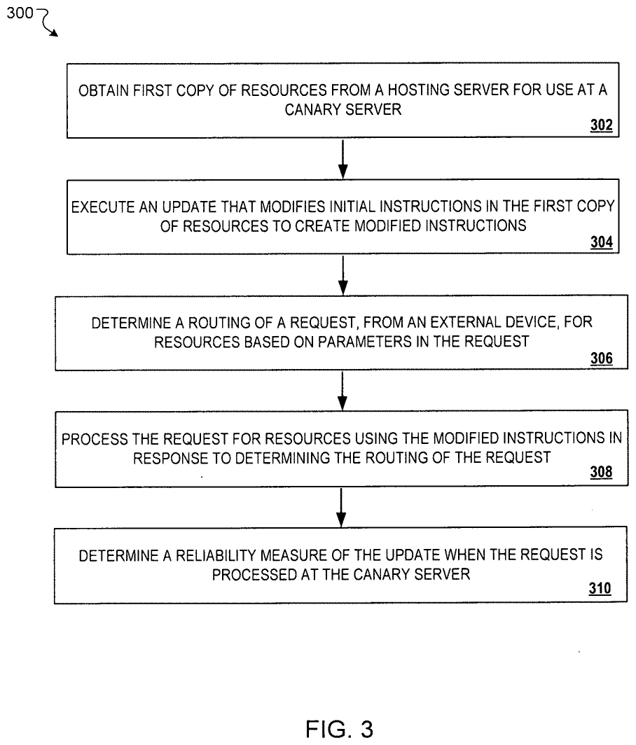

FIG. 3 is a flowchart of an example process for testing data changes in a production computer system. Process 300 can be performed using the devices and systems described in this document. Descriptions of process 300 may reference one or more of the above-mentioned computing resources of system 100. In some implementations, steps of process 300 are enabled by programmed instructions that are executable by processing devices and memory of the devices and systems described in this document.

Referring now to process 300, canary server 114 obtains a first copy of resources that include initial instructions for responding to requests from an external device (302). The first copy of resources are obtained for use at the canary server 114. For example, to obtain the first copy of resources canary server 114 can request data for the resources from canary pre-processing server 118, which in turn retrieves the data from subscriber service 128 (in some cases) or from first data storage 126, if the canary pre-processing server 118 has not received the data from subscriber service 128. Canary server 114 can initially obtain a copy of resources and data that is used by host server 112 to respond to requests in a production mode. In some implementations, canary server 114 can obtain a copy of resources by using serving engine 120 to obtain a current build version that is stored at data storage 132. For example, canary server 114 can obtain a prior resource version based on a respective timestamp for the prior resource version indicating the prior resource version is known a stable snapshot of system data. System 100 causes the prior resource version to be loaded at canary server 114 and initial instructions in the prior resource version can be modified based on a published software update.

Canary server 114 executes an update that modifies the initial instructions in the first copy of resources to create modified instructions (304). In some implementations, canary server 114 executes the modified instructions at one or more sets of servers that are used for rendering data at a webpage or to provide streaming video (or audio) content. The resource data rendered at the webpage or the streaming content are provided as a response to multiple different client device requests received over a predetermined time duration. During this time duration, system 100 monitors, using data monitor 122, computing processes executed at canary server 114 for each of the multiple different requests. Based on this monitoring, data monitor 122 can determine whether a fault condition occurs in response to canary server 114 executing the modified instructions.

A request router determines a routing of a first request for resources based on parameters in the first request (306). For example, the first request is received from the client external device to obtain resources that render a webpage. Determining the routing of the first request for resources can include determining a destination of the routing of the first request from among canary server 114 and the host server 112 based on a subset of parameters in the first request. For example, the request router 110 detects an incoming request and reads an ID for a URL query parameter of the request. In some cases, the request router 110 accesses an internal routing map, identifies a routing rule included in a data structure of the routing map, and forwards the request to either the host server 112 or canary server 114 based on the routing rule of the internal routing map.

The first request for resources is processed using the modified instructions in the first copy of resources rather than the initial instructions (308). In some implementations, the first request for resources is processed in response to the request router 110 determining that the canary server 114 is a destination of the determined routing of the first request rather than the host server 112. In some cases, canary server 114 processes multiple requests using the modified instructions in the first copy of resources for at least a predetermined time duration. While processing the multiple requests, data monitor 122 can concurrently monitor a health status of the canary server 114 to detect whether a fault occurs (or is likely to occur) in a serving cell of the canary server that obtains resources for responding to a particular request in the multiple requests.

The system determines a reliability measure of the update when at least the first request is processed at the canary server (310). The reliability measure identifies whether the update will trigger a fault during execution at production servers of the system. In some implementations, the reliability measure indicates a probability of a fault occurring at the host server 112 when the update modifies instructions in resources at the host server 112. In some cases, the reliability measure corresponds to a threshold (e.g., a static threshold) that represents a number or percentage of failed requests that will trigger a fault condition in response to the system determining that the number (or percentage) exceeds the threshold. For example, if the system determines that more than 2% of requests fail, and a failed requests threshold is set to 1%, then the system will presume the occurrence of a fault and trigger a notification indicating that there is a fault condition. Determining the reliability measure of the update can include system 100: i) processing multiple requests for a predetermined time duration using the modified instructions in the first copy of resources; and ii) detecting whether a fault occurs in a serving cell of canary server 114 that obtains resources for responding to a particular request of the multiple requests.

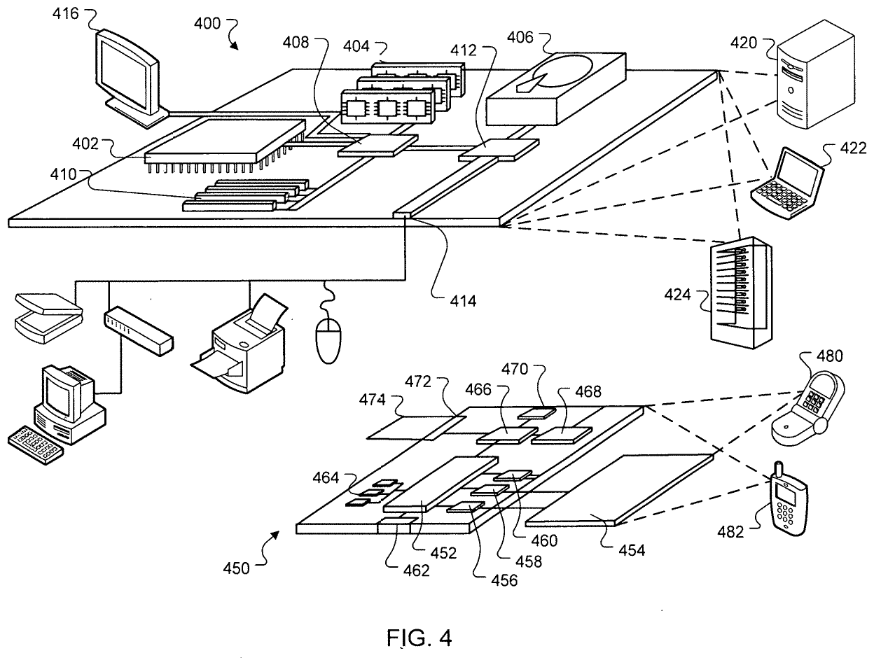

FIG. 4 is a block diagram of computing devices 400, 450 that may be used to implement the systems and methods described in this document, either as a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

As discussed above, systems and techniques described herein can be implemented in a computing system that includes a back-end component, e.g., as a data server, or that includes a middleware component such as an application server, or that includes a front-end component such as a client computer having a graphical user interface or a Web browser through which a user can interact with an implementation of the systems and techniques described here, or any combination of such back-end, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, in some embodiments, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A number of embodiments have been described. Nevertheless, it will be understood that various modifications may be made without departing from the scope of the appended claims. For example, various forms of the flows shown above may be used, with steps re-ordered, added, or removed. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method performed using a system for testing data changes in production computing servers, the method comprising:
obtaining, at a canary server, a first copy of resources that include initial instructions for responding to requests from an external device, the first copy of resources being obtained from a hosting server;
executing, at the canary server, an update that modifies the initial instructions in the first copy of resources to create modified instructions;
determining, by a request router, a routing of a first request for resources based on parameters in the first request, wherein the first request is received from the external device to obtain resources that render a webpage;
in response to the request router determining that the canary server is a destination of the determined routing of the first request, processing the first request for resources using the modified instructions in the first copy of resources rather than the initial instructions; and
determining a reliability measure of the update when at least the first request is processed at the canary server, wherein the reliability measure identifies whether the update will trigger a fault during execution at the production computing servers.

2. The method of claim 1, wherein determining the routing of the first request for resources comprises:
determining a destination of the routing of the first request from among the canary server and the hosting server based on a subset of parameters in the first request.

3. The method of claim 1, wherein the reliability measure indicates a probability of a fault occurring at the hosting server when the update modifies instructions in resources at the hosting server.

4. The method of claim 1, wherein determining the reliability measure of the update comprises:
executing the modified instructions at the canary server for multiple different requests over a predetermined time duration; and
determining, for each of the multiple different requests, whether a fault condition occurs in response to executing the modified instructions using the canary server.

5. The method of claim 1, wherein determining the reliability measure of the update comprises:
processing a plurality of requests for a predetermined time duration using the modified instructions in the first copy of resources; and
detecting whether a fault occurs in a serving cell of the canary server that obtains resources for responding to a particular request in the plurality of requests.

6. The method of claim 1, further comprising:
generating, responsive to execution of the update, multiple resource versions, each resource version comprising a distinct copy of resources obtained from the hosting server and a respective timestamp that indicates a time the resource version was generated.

7. The method of claim 6, further comprising:
determining that a fault condition occurred in response to executing the modified instructions using the canary server;
obtaining, from the storage device, a first resource version for loading at the hosting server based on the respective timestamp for the first resource version indicating the first resource version was generated before the fault condition occurred; and
using the first resource version loaded at the hosting server to process a plurality of requests for resources from multiple external devices following the fault condition.

8. The method of claim 7, wherein determining that the fault condition occurred includes determining that the fault condition occurred at the canary server and the method further comprises:
using the first resource version to process the plurality of requests at the hosting server for a time duration that is limited by the existence of the fault condition at the canary server.

9. The method of claim 7, wherein determining that the fault condition occurred includes determining that the fault condition occurred at the canary server and the method further comprises:
determining, by the request router, that the hosting server is a destination of a determined routing for a second request, based on the fault condition having occurred at the canary server; and
processing the second request at the hosting server using a prior version of resources in response to detecting that the fault condition occurred at the canary server, the prior version of resources having been previously loaded at the hosting server.

10. An electronic system for testing data changes in production computing servers, the system comprising:
one or more processing devices; and
one or more non-transitory machine-readable storage devices storing instructions that are executable by the one or more processing devices to cause performance of operations comprising:
obtaining, at a canary server, a first copy of resources that include initial instructions for responding to requests from an external device, the first copy of resources being obtained from a hosting server;
executing, at the canary server, an update that modifies the initial instructions in the first copy of resources to create modified instructions;
determining, by a request router, a routing of a first request for resources based on parameters in the first request, wherein the first request is received from the external device to obtain resources that render a webpage;
in response to the request router determining that the canary server is a destination of the determined routing of the first request, processing the first request for resources using the modified instructions in the first copy of resources rather than the initial instructions; and
determining a reliability measure of the update when at least the first request is processed at the canary server, wherein the reliability measure identifies whether the update will trigger a fault during execution at the production computing servers.

11. The electronic system of claim 10, wherein determining the routing of the first request for resources comprises:
determining a destination of the routing of the first request from among the canary server and the hosting server based on a subset of parameters in the first request.

12. The electronic system of claim 10, wherein the reliability measure corresponds to a failure threshold and determining the reliability measure comprises:
detecting whether a percentage of failed requests that are routed for processing at the canary server exceed the failure threshold; and
in response to detecting that the percentage of failed requests exceed the threshold, determining that a fault will occur at the hosting server when the update modifies instructions in resources at the hosting server.

13. The electronic system of claim 10, wherein determining the reliability measure of the update comprises:
executing the modified instructions at the canary server for multiple different requests over a predetermined time duration; and
determining, for each of the multiple different requests, whether a fault condition occurs in response to executing the modified instructions using the canary server.

14. The electronic system of claim 10, wherein determining the reliability measure of the update comprises:
processing a plurality of requests for a predetermined time duration using the modified instructions in the first copy of resources; and
detecting whether a fault occurs in a serving cell of the canary server that obtains resources for responding to a particular request in the plurality of requests.

15. The electronic system of claim 10, wherein the operations further comprise:
generating, responsive to execution of the update, multiple resource versions, each resource version comprising a distinct copy of resources obtained from the hosting server and a respective timestamp that indicates a time the resource version was generated; and
storing the multiple resource versions in a storage device.

16. The electronic system of claim 15, wherein the operations further comprise:
determining that a fault condition occurred in response to executing the modified instructions using the canary server;
obtaining, from the storage device, a first resource version for loading at the hosting server based on the respective timestamp for the first resource version indicating the first resource version was generated before the fault condition occurred; and
using the first resource version loaded at the hosting server to process a plurality of requests for resources from multiple external devices following the fault condition.

17. The electronic system of claim 16, wherein determining that the fault condition occurred includes determining that the fault condition occurred at the canary server and the operations further comprise:
using the first resource version to process the plurality of requests at the hosting server for a time duration that is limited by the existence of the fault condition at the canary server.

18. The electronic system of claim 16, wherein determining that the fault condition occurred includes determining that the fault condition occurred at the canary server and the operations further comprise:
determining, by the request router, that the hosting server is a destination of a determined routing for a second request, based on the fault condition having occurred at the canary server; and
processing the second request at the hosting server using a prior version of resources in response to detecting that the fault condition occurred at the canary server, the prior version of resources having been previously loaded at the hosting server.

19. One or more non-transitory machine-readable storage devices storing instructions that are executable by one or more processing devices to cause performance of operations comprising:
obtaining, at a canary server, a first copy of resources that include initial instructions for responding to requests from an external device, the first copy of resources being obtained from a hosting server;
executing, at the canary server, an update that modifies the initial instructions in the first copy of resources to create modified instructions;
determining, by a request router, a routing of a first request for resources based on parameters in the first request, wherein the first request is received from the external device to obtain resources that render a webpage;
in response to the request router determining that the canary server is a destination of the determined routing of the first request, processing the first request for resources using the modified instructions in the first copy of resources rather than the initial instructions; and
determining a reliability measure of the update when at least the first request is processed at the canary server, wherein the reliability measure identifies whether the update will trigger a fault during execution at the production computing servers.

20. The machine-readable storage devices of claim 19, wherein determining the routing of the first request for resources comprises:
determining a destination of the routing of the first request from among the canary server and the hosting server based on a subset of parameters in the first request.
